(19) United States
(12) Patent Application Publication
(10) Pub. No.: US 2014/0210134 A1
(43) Pub. Date: Jul. 31, 2014

(54) NANOIMPRINTING APPARATUS, NANOIMPRINTING METHOD, DISTORTION IMPARTING DEVICE AND DISTORTION IMPARTING METHOD

(71) Applicant: FUJIFILM Corporation, Tokyo (JP)

(72) Inventors: Satoshi WAKAMATSU, Haibara-gun (JP); Akiko HATTORI, Haibara-gun (JP)

(73) Assignee: FUJIFILM Corporation, Tokyo (JP)

(21) Appl. No.: 14/227,527

(22) Filed: Mar. 27, 2014

Related U.S. Application Data
(63) Continuation of application No. PCT/JP2012/073767, filed on Sep. 11, 2012.

(30) Foreign Application Priority Data
Sep. 28, 2011 (JP) 2011-212135

(51) Int. Cl. B29C 59/02

(52) U.S. Cl. CPC B29C 59/02
USPC 264/293

(57) ABSTRACT

A nanoimprinting apparatus is equipped with: a distortion imparting device that applies external force onto an imprinting member, which is one of a mold and a substrate, to maintain the imprinting member in a predetermined flexed state, thereby imparting permanent distortion to the imprinting member; and an imprinting unit that utilizes the imprinting member having the permanent distortion imparted thereto by the distortion imparting device to execute imprinting. A pattern of protrusions and recesses of the mold can be caused to contact resist from the central portion thereof utilizing any imprinting member, regardless of the rigidity of the imprinting member.

### TECHNICAL FIELD

The present invention is related to a nanoimprinting apparatus that performs nanoimprinting operations employing a mold having a predetermined pattern of protrusions and recesses on the surface thereof, and a nanoimprinting method that employs the nanoimprinting apparatus. The present invention is also related to a distortion imparting device and a distortion imparting method which are employed in the nanoimprinting apparatus and the nanoimprinting method.

### BACKGROUND ART

Nanoimprinting is a development of the embossing technique, which is well known in the production of optical disks. In the nanoimprinting method, a mold (commonly referred to as a mold, a stamper, or a template), on which a pattern of protrusions and recesses is formed, is pressed against resist coated on a substrate, which is an object to be processed. Pressing of the original onto the resist causes the resist to mechanically deform or to flow, to precisely transfer the fine pattern. If a mold is produced once, nano level fine structures can be repeatedly molded in a simple manner. Therefore, the nanoimprinting method is an economical transfer technique that produces very little harmful waste and discharge. Therefore, there are high expectations with regard to application of the nanoimprinting method in various fields.

In nanoimprinting, it is important for resist to accurately fill the recesses of patterns of protrusions and recesses when molds are pressed against the resist. In the case that residual gas is present in the recesses, such portions will become defects in resist patterns.

Therefore, Japanese Unexamined Patent Publication No. 2007-305895 and PCT Japanese Publication No. 2009-518207, for example, disclose methods in which a holding member 91 holds a mold 90 and a pump 92 performs suction such that the mold 90 flexes in a convex shape toward the surface on which a pattern of protrusions and recesses is formed when the mold 90 is pressed against resist 94 on a substrate 93, as illustrated in FIG. 7. By performing imprinting while deforming the central portion of the mold 90 in a convex shape in this manner, the mold 90 will sequentially come into close contact with the resist starting form the central portion. As a result, the mold and the resist will come into close contact while pressing gas out from the central portion toward the outer periphery, and residual gas can be suppressed.

The same advantageous effect can be obtained by flexing substrates for imprinting as well.

### DISCLOSURE OF THE INVENTION

There are cases in which the dimensions of the aforementioned imprinting members (the expression “imprinting member” refers to molds and substrates for imprinting) change when peripheral conditions such as atmospheric pressure change. Accordingly, in cases that it is necessary to suppress such changes in the dimensions of imprinting members, imprinting members having high rigidity are utilized.

However, the methods disclosed in Japanese Unexamined Patent Publication No. 2007-305895 and PCT Japanese Publication No. 2009-518207 have a problem that imprinting members cannot be sufficiently deformed in cases that the rigidity thereof is high.

The present invention has been developed in view of the foregoing circumstances. It is an object of the present invention to provide a nanoimprinting apparatus, a nanoimprinting method, a distortion imparting device, and a distortion imparting method that enables contact between a pattern of protrusions and recesses of a mold and resist to be initiated at the center thereof utilizing any imprinting member, regardless of the rigidity of the imprinting member.

A nanoimprinting apparatus of the present invention that achieves the above object is characterized by comprising:

a distortion imparting device that applies external force onto an imprinting member, which is one of a mold having a fine pattern of protrusions and recesses on a first surface thereof and a substrate for nanoimprinting having resist on a first surface thereof, to maintain the imprinting member in a predetermined flexed state, thereby imparting permanent distortion to the imprinting member; and

an imprinting unit that utilizes the imprinting member having the permanent distortion imparted thereto and presses the pattern of protrusions and recesses of the mold onto the resist provided on the substrate, to transfer the pattern of protrusions and recesses to the resist.

In the present specification, the expression “imprinting member” refers collectively to the mold and the substrate for imprinting.

The expression “permanent distortion” refers to distortion that remains in a material after external force is applied to the material then removed.

In the nanoimprinting apparatus of the present invention, it is preferable for:

the distortion imparting device to comprise a frame having an opening, that forms a chamber above the first surface of the imprinting member when the imprinting member is placed at the opening with the first surface facing the interior of the frame, and a pressure control section that depressurizes or pressurizes the interior of the chamber.

The “first surface” of the imprinting member refers to the surface on which the pattern of protrusions and recesses is formed in the case that the imprinting member is the mold, and refers to the surface on which resist is present in the case that the imprinting member is the substrate.

In the nanoimprinting apparatus of the present invention, it is preferable for:

the distortion imparting device to further comprise a heating section that heats the interior of the chamber.

In the nanoimprinting apparatus of the present invention, it is preferable for:

the distortion imparting device to further comprise a mold release agent supplying section that supplies a mold release agent to the interior of the chamber.

In the nanoimprinting apparatus of the present invention, it is preferable for:

the distortion imparting device to further comprise a humidity controlling section that controls the humidity of interior of the chamber.

Alternatively, in the nanoimprinting apparatus of the present invention, it is preferable for:

the distortion imparting device to comprise a support member that supports the outer edges of the imprinting member, and a pressing member that presses a second surface of the imprinting member while the imprinting member is being supported by the support member.

The “second surface” of the imprinting member refers to the surface opposite the surface on which the pattern of protrusions and recesses is formed in the case that the imprinting member is the mold, and refers to the surface opposite the surface on which resist is present in the case that the imprinting member is the substrate.

A nanoimprinting method of the present invention is characterized by comprising:

utilizing an imprinting member having permanent distortion imparted thereon; and

pressing a pattern of protrusions and recesses of a mold onto resist provided on a substrate, to transfer the pattern of protrusions and recesses onto the resist.

A first distortion imparting device of the present invention has the function of applying external force onto an imprinting member, which is one of a mold having a fine pattern of protrusions and recesses on a first surface thereof and a substrate for nanoimprinting having resist on a first surface thereof, to maintain the imprinting member in a predetermined flexed state, thereby imparting permanent distortion to the imprinting member, and comprises:

a frame having an opening, that forms a chamber above the first surface of the imprinting member when the imprinting member is placed at the opening with the first surface facing the interior of the frame; and

a pressure control section that depressurizes or pressurizes the interior of the chamber.

A second distortion imparting device of the present invention has the function of applying external force onto an imprinting member, which is one of a mold having a fine pattern of protrusions and recesses on a first surface thereof and a substrate for nanoimprinting having resist on a first surface thereof, to maintain the imprinting member in a predetermined flexed state, thereby imparting permanent distortion to the imprinting member, and comprises:

a support member that supports the outer edges of the imprinting member; and

a pressing member that presses a second surface of the imprinting member while the imprinting member is being supported by the support member.

A first distortion imparting method of the present invention is executed to apply external force onto an imprinting member, which is one of a mold having a fine pattern of protrusions and recesses on a first surface thereof and a substrate for nanoimprinting having resist on a first surface thereof, to maintain the imprinting member in a predetermined flexed state, thereby imparting permanent distortion to the imprinting member, and comprises the steps of:

utilizing the first distortion imparting device of the present invention;

forming a chamber above the first surface of the imprinting member by placing the imprinting member at the opening of the frame with the first surface facing the interior of the frame; and

depressurizing or pressurizing the interior of the chamber using the pressure control section.

In the first distortion imparting method of the present invention, it is preferable for:

the distortion imparting device to further comprise a mold release agent supplying section for supplying a mold release agent to the interior of the chamber; and for

the mold release agent supplying section to supply the mold release agent to the interior of the chamber along with depressurization or pressurization of the interior of the chamber by the pressure control section.

A second distortion imparting method of the present invention is executed to apply external force onto an imprinting member, which is one of a mold having a fine pattern of protrusions and recesses on a first surface thereof and a substrate for nanoimprinting having resist on a first surface thereof, to maintain the imprinting member in a predetermined flexed state, thereby imparting permanent distortion to the imprinting member, and comprises the steps of:

utilizing the second distortion imparting device of the present invention;

supporting the outer edges of the imprinting member with the support member; and

pressing a second surface of the imprinting member with the pressing member while the imprinting member is being supported by the support member.

The nanoimprinting apparatus and the nanoimprinting method of the present invention employ the imprinting member having permanent distortion imparted thereon by the distortion imparting device, and pressing the pattern of protrusions and recesses of the mold onto the resist provided on the substrate for imprinting, to transfer the pattern of protrusions and recesses onto the resist. The distortion imparting device can sufficiently apply external force necessary to deform the imprinting member, and can impart permanent distortion to the imprinting member such that the central portion thereof becomes convex, regardless of the rigidity of the imprinting member. As a result, it becomes possible for contact between the pattern of protrusions and recesses of the mold and the resist to be initiated at the center thereof utilizing any imprinting member during nanoimprinting operations, regardless of the rigidity of the imprinting member.

The first distortion imparting device and the first distortion imparting method of the present invention form a chamber above the first surface of the imprinting member by placing the imprinting member at the opening of the frame with the first surface facing the interior of the frame, and depressurizing or pressurizing the interior of the chamber using the pressure control section. By utilizing the first distortion imparting device, external force necessary to deform the imprinting member can be sufficiently applied, and permanent distortion can be imparted to the imprinting member such that the central portion thereof becomes convex, regardless of the rigidity of the imprinting member. As a result, it becomes possible for contact between the pattern of protrusions and recesses of the mold and the resist to be initiated at the center thereof utilizing any imprinting member during nanoimprinting operations, regardless of the rigidity of the imprinting member.

The second distortion imparting device and the second distortion imparting method of the present invention support the outer edges of the imprinting member with the support member and pressing the second surface of the imprinting member with the pressing member while the imprinting member is being supported by the support member. By utilizing the second distortion imparting device, external force necessary to deform the imprinting member can be sufficiently applied, and permanent distortion can be imparted to the imprinting member such that the central portion thereof becomes convex, regardless of the rigidity of the imprinting member. As a result, it becomes possible for contact between the pattern of protrusions and recesses of the mold and the resist to be initiated at the center thereof utilizing any imprinting member during nanoimprinting operations, regardless of the rigidity of the imprinting member.

### BRIEF DESCRIPTION OF THE DRAWINGS

FIG. 1 is a plan view that schematically illustrates the structure of a nanoimprinting apparatus according to an embodiment of the present invention.

FIG. 2 is a sectional end view that schematically illustrates the structure of a distortion imparting device according to an embodiment of the present invention.

FIG. 3 is a graph that schematically shows the relationship between amounts of deformation of a mold and external forces.

FIG. 4 is a sectional end view that schematically illustrates the structure of an alternate distortion imparting device.

FIG. 5 is a sectional end view that schematically illustrates the structure of an imprinting unit according to an embodiment of the present invention.

FIG. 6 is a flow chart that illustrates the steps of an imprinting operation that employs the imprinting apparatus.

FIG. 7 is a sectional end view that schematically illustrates the structure of a conventional imprinting unit.

### BEST MODE FOR CARRYING OUT THE INVENTION

Hereinafter, embodiments of the present invention will be described with reference to the attached drawings. However, the present invention is not limited to the embodiments to be described below. Note that in the drawings, the dimensions of the constitutive elements are drawn differently from the actual dimensions thereof, in order to facilitate visual recognition thereof.

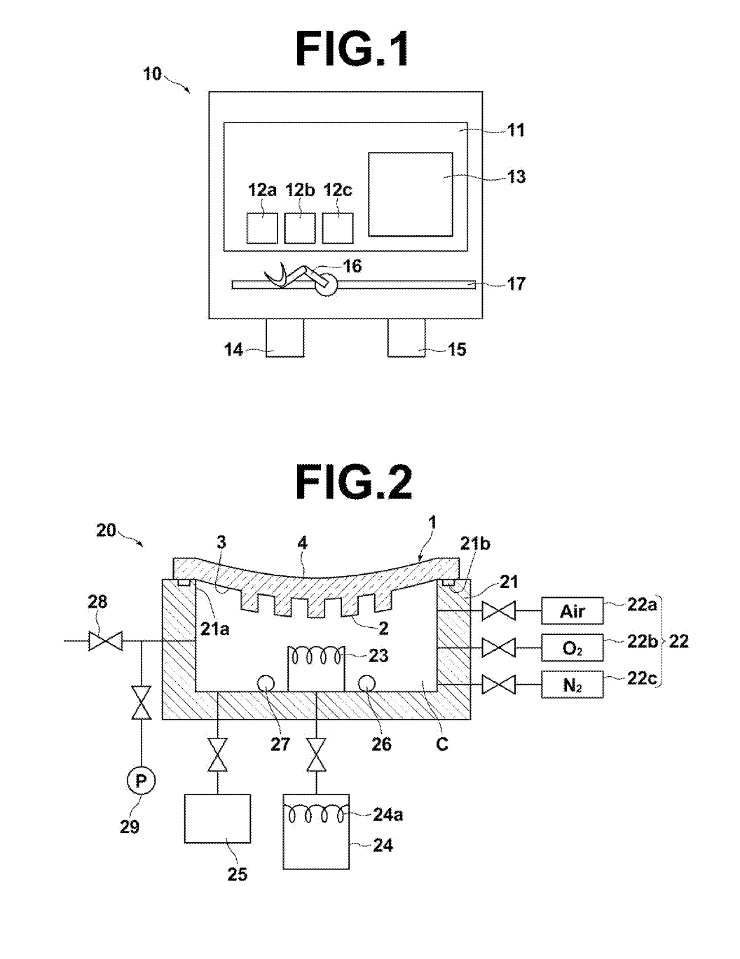

FIG. 1 is a plan view that schematically illustrates the structure of a nanoimprinting apparatus 10 according to an embodiment of the present invention. FIG. 2 is a sectional end view that schematically illustrates the structure of a distortion imparting device according to an embodiment of the present invention.

As illustrated in FIG. 1, the nanoimprinting apparatus 10 of the present embodiment is equipped with: a base 11; three mold standby sections 12a, 12b, and 12c provided on the base 11; an imprinting section 13; a mold cassette loader 14; a substrate cassette loader 15; a conveying device 16; a rail 17; and a resist coating mechanism (not shown).

A nanoimprinting method according to an embodiment of the present invention employs the nanoimprinting apparatus 10 to press patterns of protrusions and recesses of molds 1, to which permanent distortion has been imparted, against droplets of resist coated on substrates, to transfer the patterns of protrusions and recesses onto resist films formed by the droplets bonding with each other.

### (Mold Standby Sections)

The mold standby sections 12a, 12b, and 12c are mechanisms for imparting permanent distortion to the molds 1 while holding the molds 1 in a standby state. For example, each of the mold standby sections 12a, 12b, and 12c is constituted by a distortion imparting device 20 such as that illustrated in FIG. 2. It is not necessary for all of the mold standby sections 12a, 12b, and 12c to be constituted by distortion imparting devices having the same structure. In addition, the number of mold standby sections can be increased or decreased as necessary.

The distortion imparting device 20 applies external force onto the molds 1, on a first surface 3 (patterned surface) of which a fine pattern of protrusions and recesses is formed, to maintain the imprinting member in a predetermined flexed state, thereby imparting permanent distortion to the molds 1. The “predetermined flexed state” is a deformed state to be maintained while the external force is being applied in order to obtain an imprinting member to which permanent distortion has been imparted with a desired deformed state. In many cases, imprinting members return to their original states by elastic deformation when external force is no longer applied. Therefore, the degree of deformation in the deformed state while the external force is being applied is greater than the degree of deformation in an ultimately desired deformed state. In addition, the expression “applies external force” includes cases in which the distortion imparting device directly applies external force to the mold by a mechanical mechanism and cases in which the distortion imparting device indirectly applies external force to the mold by pressure differences in the periphery of the mold by a control mechanism.

The distortion imparting device 20 may be of any configuration as long as it is capable of imparting permanent distortion to the molds 1. In the present embodiment, for example, the distortion imparting device 20 is equipped with: a frame 21; a gas supply section 22; a heater 23; a mold release agent supplying section 24; a humidity control section 25; a low pressure mercury lamp 26; a crystal oscillator 27; a leak valve 28; and a pump 29.

The frame 21 is a member that constitutes the main body of the distortion imparting device 20, and functions as a setting base on which a mold 1 is placed. The frame 21 has an opening 21a. The mold 1 is placed at the opening 21a such that the patterned surface 3 faces the interior of the frame 21. In the present embodiment, placement of the mold 1 is performed by suctioning chucks 21b provided adjacent to the opening 21a, as illustrated in FIG. 2. Alternatively, a resin O ring may be provided above the opening 21a, and the mold 1 may simply be placed on the O ring.

When the mold 1 is placed at the opening 21a, the mold 1 and the frame 21 form a chamber C. The chamber C is of a sealed structure. The atmosphere within the chamber C is controlled by the pump 29 or the gas supplying section 22 depressurizing or pressurizing the atmosphere, the mold release agent supplying section 24 supplying a vaporized mold release agent, and by the humidity control section 25 controlling the humidity of the atmosphere. By adopting this configuration, an environment in which the amount of fine particulate foreign matter is sufficiently reduced can be formed. As a result, it becomes possible to prevent adhesion of fine particulate foreign matter to the patterned surface 3 of the mold 1.

The gas supplying section 22 is constituted by an atmosphere supplying section 22a, an oxygen supplying section 22b, and a nitrogen supplying section 22c, for example. Supplying sections for supplying other gases may be provided as necessary. The gas supplying section 22 supplies gas into the chamber C when the interior of the chamber C is to be pressurized or to be filled with inert gas. Note that it is preferable for gas which has been filtered to sufficiently remove fine particulate foreign matter to be utilized. The leak valve 28 is a valve for releasing pressure within the chamber C. The pump 29 is an exhaust means for evacuating (depressurizing) the interior of the chamber C. The gas supply section 22, the leak valve 28, and the pump 29 together correspond to the pressure control section of the present invention.

The heater 23 is utilized when the mold 1 is to be heated and/or when the temperature of the atmosphere within the chamber C is to be raised. The mold 1 is heated, for example, to promote the generation of permanent distortion therein. Meanwhile, the temperature of the atmosphere within the chamber C is raised, for example, to promote binding of a mold release agent to the mold 1 as will be described later.

The mold release agent supplying section 24 supplies a vaporized mold release agent to the interior of the chamber C. The configuration of the present embodiment described above enables a mold release process for forming a mold release layer on the patterned surface 3 to be administered while the distortion imparting device 20 imparts permanent distortion to the mold 1.

The humidity control section 25 controls the humidity of the interior of the chamber C. The coating rate of the mold release agent with respect to the mold 1 can be improved by controlling the humidity within the chamber C.

The low pressure mercury lamp 26 irradiates light onto the patterned surface 3 of the mold 1. Organic matter on the patterned surface 3 can be decomposed and removed, thereby performing dry cleansing, by irradiating light thereon from the low pressure mercury lamp 26 while oxygen is present in the interior of the chamber C.

The crystal oscillator 27 is a sensor that monitors the deposited film thickness of the mold release agent during the mold release process. For example, the crystal oscillator 27 which is utilized as a sensor has a basic frequency within a range from 1 MHz to 20 MHz and electrodes on both sides thereof. A thin film of a material which is the same as that of the surface of the mold 1 is formed on one surface of the crystal oscillator 28 such that the crystal oscillator 27 functions as a sensor for the mold release agent. For example, a thin film of silicon oxide is formed on one surface of the crystal oscillator 27 in the case that the material of the mold 1 is quartz.

By employing the distortion imparting device 20 having the structure described above, the cleanliness of the patterned surface 3 of the mold 1 can be maintained, cleansing of the mold sufficient for imprinting, and a mold release process can be executed in a simple manner while imparting permanent distortion to the mold 1 without excessively large equipment.

In addition to administering cleansing and/or processes (the distortion imparting process and the mold release process) to unused and unprocessed molds 1, the distortion imparting device 20 can simply hold unused and processed molds 1 in a standby state, or administer cleansing and/or processes on used molds 1.

The distortion imparting device 20 of the present embodiment imparts permanent distortion to the molds 1 by depressurizing or pressurizing the interior of the chamber C after placing the mold 1 at the opening of the frame with one of the surfaces thereof facing the interior of the frame. For example, in the case that the interior of the chamber C is depressurized, the mold 1 is pressed by external atmospheric pressure such that the mold 1 flexes to become convex (when the patterned surface 3 is designated as a front surface, the opposite surface is designated as a back surface, and the direction of the front surface of the mold 1 is designated as a positive direction), as illustrated in FIG. 2. In contrast, in the case that the interior of the chamber C is pressurized, the mold 1 will be pressed by internal pressure and flex to become a concave shape.

The amount of flexure, the amount of time that the flexed state is maintained for, and the temperature of the mold 1 are important parameters in the generation of permanent distortion. Optimal values for these parameters also differ depending on the ultimately desired deformed state of the mold 1 and the material of the mold 1. However, the parameters can be set to be within the following approximate ranges. The amount of flexure (the amount of displacement between the outer edge portions and the central portion of the mold 1) is generally set to be within a range from 1 μm to 5000 μm, preferably within a range from 10 μm to 1000 μm, and more preferably within a range from 50 μm to 500 μm. The amount of time that the flexed state is maintained for is generally within a range from 10 minutes to 100 hours, preferably within a range from 1 hour to 50 hours, and more preferably within a range from 12 hours to 24 hours. The temperature within the chamber C is generally set to a value greater than or equal to room temperature and less than the glass transition point of the mold.

Stress relief is generated in the mold 1 under the above conditions, and permanent distortion remains in the shape thereof.

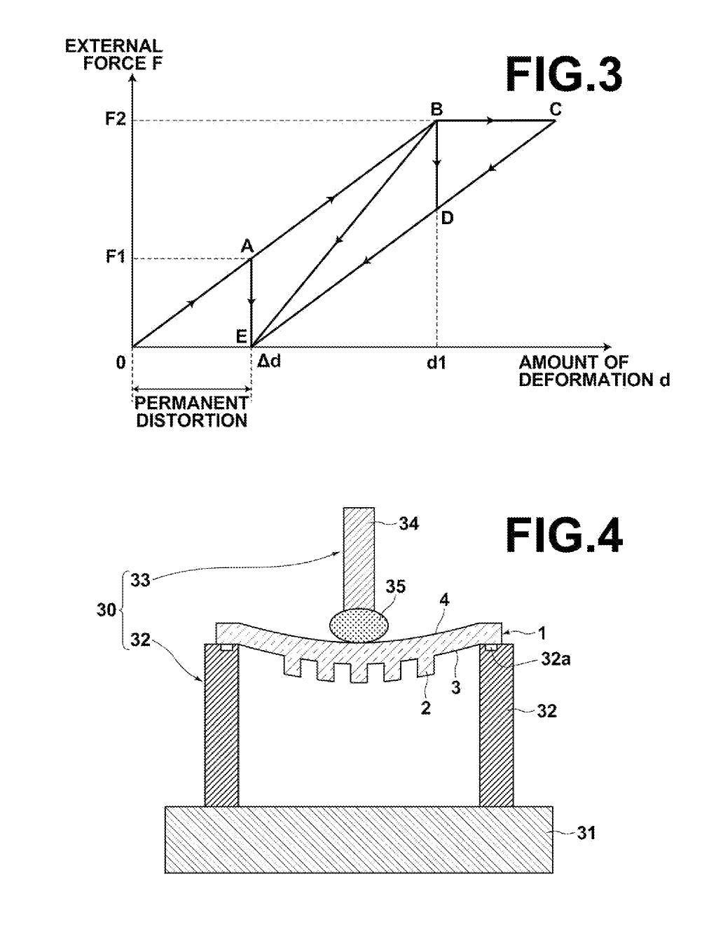

In the present specification, the expression “permanent distortion” refers to distortion that remains in a material after external force is applied to the material then removed. This distortion is also referred to as “residual distortion”. Permanent distortion is generated in cases that in which external forces exceed the elastic limit for stress of a material, or cases in which a material is maintained in high temperature and/or under high external pressure for a long amount of time. FIG. 3 is a graph that schematically shows the relationship between amounts of deformation of a mold and external forces. For example, if the state of a mold 1 prior to permanent distortion being imparted thereto is designated as the origin of the graph, the state of the mold 1 to which permanent distortion is imparted can be represented as point E in the graph. In the present invention, the path traveled from the origin to the point E is irrelevant. That is, it is sufficient for a desired deformed state to be maintained when imprinting operations are performed.

For example, distortion in the case that a path “from the origin to point A to point E” is taken in FIG. 3, distortion remains even if external force is reduced from F=F1 to F=0. That is, the distortion is that based on plastic deformation exceeding the elastic limit of the material. The amount of deformation increases while external force F is maintained at F=F2 in the case that a path “from the origin to point A to point B to point C to point D to point E” is taken. This distortion is caused by the so called creep phenomenon. Alternatively, distortion achieved after taking a path “from the origin to point A to point B to point D to point E” and distortion achieved after taking a path “from the origin to point A to point B to point E” is also permanent distortion as defined in the present invention. Note that considering the fact that the amount of permanent distortion which is presumed in nanoimprinting is approximately several mm, it is believed that distortion based on plastic deformation is not likely to occur with materials such as Si, quartz, etc., which are generally utilized as materials of the molds 1.

In addition, the permanent distortion imparting device and the permanent distortion imparting method are not limited to that illustrated in FIG. 2. For example, FIG. 4 is a sectional end view that schematically illustrates the structure of a distortion imparting device 30 that imparts permanent distortion by mechanically applying external force.

The distortion imparting device 30 is equipped with: a base 31; a support member 32 fixed on the base 31 that supports the outer edges of the molds 1; and a pressing member 33 that presses the back surfaces 4 of the molds 1 while the molds 1 are supported by the support member 32. The support member 32 is equipped with suctioning chucks 32a, and the suctioning chucks 32a suction and hold the outer edges of the molds 1. In addition, the pressing member 33 has an arm portion 34 and a pad portion 35 provided at the leading end of the arm portion 34. The distortion imparting device 30 presses the back surface 4 of a mold 1 while the mold 1 is being supported, to impart permanent distortion to the mold 1. As a further alternative, the distortion imparting device may be that which causes flexure to occur only by applying heat.

### (Imprinting Section)

The imprinting section 13 is a mechanism that presses the patterns 2 of protrusions and recesses of the molds 1 onto resist provided on the substrates, to transfer the patterns 2 of protrusions and recesses onto the resist. The imprinting section 13 is constituted by a imprinting unit 40 such as that described below, for example.

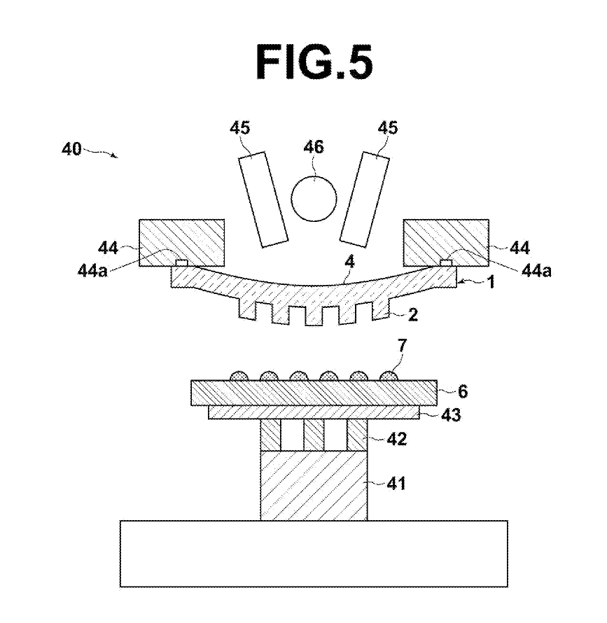

FIG. 5 is a sectional end view that schematically illustrates the structure of the imprinting unit according to an embodiment of the present invention. The imprinting unit 40 of the present embodiment is constituted by: an xyz stage 41; a loading cell 42; a substrate stage 43; a mold holding section 44; an alignment camera 45; and an ultraviolet light source 46.

The xyz stage 41 is an adjusting mechanism that adjusts the position of substrates 6 for imprinting in the x direction, the y direction, and the z direction.

The loading cell 42 is a mechanism that moves the substrate stage 43 in the vertical direction, and is capable of measuring separation forces when the molds 1 are separated from resist 7.

The substrate stage 43 is a base on which the substrates 6 are placed.

The mold holding section 44 suctions and holds the back surfaces 4 of a mold 1 with suctioning chucks 44a, and holds the mold 1 such that the pattern 2 of protrusions and recesses faces resist 7 provided on a substrate 6. The mold holding section 44 may be configured to move vertically.

The alignment camera 45 enables observation of the relative position of the molds 1 with respect to the substrates 6 from the back surfaces 4 of the molds 1.

The ultraviolet light source 46 irradiates ultraviolet light to cure photocurable resist 7 provided on the substrates 6.

### (Mold Cassette Loader and Substrate Cassette Loader)

The mold cassette loader 14 and the substrate cassette loader 15 are respectively equipped with a base for placing cassettes that house molds 1 and substrates 6 therein, and a mechanism for opening and closing a case that houses the cassettes. In the case that the shape of the molds 1 and the shape of the substrates 6 are different, cassettes corresponding to the respective shapes are utilized. In the case that the shapes of the molds 1 and the substrates 6 are the same, the molds 1 and the substrates 6 may be housed in the same cassette. By opening the case, an arm of the conveying device 16 is enables to access the molds 1 and the substrates 6 within the cassettes, and conveyance of the molds 1 and the substrates 6 becomes possible.

### (Conveyance Device and Rail)

The conveyance device 16 is constituted by: a hand portion that holds the molds 1 and the substrates 6; the arm portion having one or more joints; a Z stage that controls the position of the conveyance device 16 in the height direction; and a runner mechanism capable of moving along the rail 17. The conveyance device 16 moves among the mold standby sections 12a, 12b, and 12c, the imprinting section 13, the mold cassette loader 14 and the substrate cassette loader 15, and functions to convey the molds 1 and the substrates 6.

### (Resist Coating Mechanism)

The ink jet method, the spin coat method, and the dip coat method are examples of methods that can be employed by the resist coating mechanism. For example, if the resist coating mechanism adopts the ink jet method, the resist coating mechanism may be provided within the imprinting unit 40. However, it is not necessary for the imprinting apparatus 10 to be equipped with a resist coating mechanism if substrates which are coated with resist in advance are prepared.

### (Mold)

The molds to be utilized by the present embodiment may be produced by the following steps prior to permanent distortion being imparted thereto. First, a Si substrate is coated with a resist liquid having a PHS (polyhydroxy styrene) series chemically amplified resist, novolac series resist, or an acrylic resin such as PMMA (polymethyl methacrylate) as a main component by the spin coat method or the like, to form a resist layer. Next, a laser beam (or an electron beam), which is modulated according to a desired pattern of protrusions and recesses, is irradiated onto the resist layer to expose a pattern of protrusions and recesses. Thereafter, the photoresist layer undergoes a development process to remove the exposed portions. Finally, selective etching is performed by RIE (Reactive Ion Etching) or the like using the resist layer, from which the exposed portions are removed, as a mask, to obtain a Si mold having the desired pattern of protrusions and recesses.

Meanwhile, the mold is not limited to that described above, and it is also possible to employ a quartz mold. In this case, the quartz mold may be produced by the same steps as those used for producing the Si mold, or by the method for producing copies of molds to be described later.

Increasing the amount of adsorbed water on the surface of the mold is an effective measure to increase the mold release agent coating rate on the surface of the mold and to shorten the time required for the mold release process.

Modifying the properties of the surface of the mold to becomes hydrophilic and increasing the relative humidity of the environment are methods for increasing the amount of adsorbed water on the surface of the mold. Examples of methods for modifying the properties of the surface of the mold to become hydrophilic include: wet cleansing methods that employ chemical agents; dry cleansing methods that employ plasma or UV ozone; and methods that combine the wet and dry cleansing methods. The preferable range of relative humidity is from 20% to 70%, and more preferably within a range from 30% to 50%.

In the present embodiment, the mold release process can be administered in a simple manner by the distortion imparting devices 20. Therefore, a dry cleansing method that employs UV ozone, which does not require excessively large equipment, is preferable. In the UV ozone cleansing method, the low pressure mercury lamp 26 irradiates ultraviolet light having a peak wavelength close to 185 nm is irradiated onto the patterned surface, to activate oxygen included in the atmosphere in the vicinity of the patterned surface 3. Thereby, organic matter on the patterned surface 3 is oxidized and removed.

### (Mold Release Agent)

In the present embodiment, mold release processes are administered onto the patterned surfaces 3 to improve the mold release properties between the resist 7 and the surfaces of the molds 1. Examples of mold release agents to be utilized in the mold release processes include: Optool™ DSX by Daikin Industries K.K.; and Novec™ EGC-1720 by Sumitomo 3M K.K.

Alternatively, other known fluorine resins, hydrocarbon series lubricants, fluorine series lubricants, fluorine series silane coupling agents, etc., may be utilized.

Examples of fluorine series resins include: PTFE (polytetrafluoroethylene); PFA (tetrafluoroethylene perfluoroalkylvinylether copolymer); FEP (tetrafluoroetylene hexafluoropropylene copolymer); and ETFE (tetrafluoroethylene ethylene copolymer).

Examples of hydrocarbon series lubricants include: carboxylic acids such as stearic acid and oleic acid; esters such as stearic acid butyl; sulfonic acids such as octadecylsulfonic acid; phosphate esters such as monooctadecyl phosphate; alcohols such as stearyl alcohol and oleyl alcohol; carboxylic acid amides such as stearic acid amide; and amines such as stearyl amine.

Examples of fluorine series lubricants include lubricants in which a portion or the entirety of the alkyl groups of the aforementioned hydrocarbon series lubricants are replaced with fluoroalkyl groups or perfluoropolyether groups.

The perfluoropolyether groups may be perfluoromethylene oxide polymers, perfluoroethylene oxide polymers, perfluoro-n-propylene oxide polymers (CF₂CF₂CF₂O)ₙ, perfluoroisopropylene oxide polymers (CF(CF₃)CF₂O)ₙ, copolymers of the aforementioned polymers, etc. Here, the subscript n represents the degree of polymerization. Fomblin™ Z-DOL by Solvay Solexis is a specific example of such a substance.

It is preferable for the fluorine series silane coupling agents to have at least one and preferably one to 10 alkoxy silane groups and chloro silane groups in each molecule, and to have a molecular weight within a range from 200 to 10,000.

—Si (OCH₃)₃ and —Si (OCH₂CH₃)₃ are examples of the alkoxy silane group. Meanwhile, examples of the chloro silane groups include —Si(Cl)₃. Specific examples of the fluorine series silane coupling agents include: heptadecafluoro-1,1,2,2-tetra-hydrodecyltrimethoxysilane; pentafluorophenylpropyldimethylchlorosilane; tridecafluoro-1,1,2,2-tetra-hydrooctyltriethoxysilane; and tridecafluoro-1,1,2,2-tetra-hydrooctyltrimethoxysilane.

It is preferable for mold release agents described above to be of low molecular weight from the viewpoint of efficient evaporation within the chamber C. Accordingly, it is preferable for the mold release agent to include a compound having a molecular weight within a range from 200 to 10,000, more preferable within a range from 200 to 5,000, and most preferably within a range from 200 to 1,000.

### (Mold Release Process)

Hereinafter, the method by which the mold release process is administered onto a patterned surface 3 utilizing the chamber C will be described. In the present embodiment, the chamber C is connected to the mold release agent supplying section 24. It is possible to perform the mold release process more efficiently as the distance between the mold release supplying section 24 and the patterned surface 3 is shorter. In FIG. 2, the mold release agent supplying section 24 and the chamber C are connected by a pipe via a valve. Alternatively, a container having the mold release agent therein may be provided within the chamber C, and the mold release process may be controlled by opening and closing the lid of the container or the like.

If the chamber C is connected to the mold release agent supplying section 24, it is possible to protect the patterned surface 3 from fine particulate foreign matter and to administer the mold release process at the same time. For example, the mold release agent supplying section 24 has a heater 24a. The mold release agent evaporates in the mold release agent supplying section 24, and the evaporated mold release agent (mold release agent vapor) is supplied to the interior of the chamber C. The mold release agent vapor is adsorbed onto the patterned surface 3 to form a mold release agent layer. Although variance will occur depending on the vapor pressure of the mold release agent, most mold release agents will evaporate under conditions of atmospheric pressure and room temperature of approximately 25° C. Accordingly, even if the amount of the mold release agent is small, it is possible to administer the mold release process by exposing the patterned surface 3 to the mold release agent vapor for a long period of time, as long as the mold release agent evaporates. In addition, by depressurizing the interior of the chamber C and/or by raising the temperature using the heater 24a, the amount of mold release agent vapor within the atmosphere can be increased.

In the case that a silane coupling agent is utilized as the mold release agent, coating of the patterned surface 3 with the mold release agent can be improved, by controlling the humidity within the chamber C with the humidity control section 25.

The crystal oscillator 27 is set within the chamber C, and is initialized by undergoing the same dry cleansing as that administered to the patterned surface 3. Thereafter, changes in the resonant frequency of the crystal oscillator 27 when the mold release agent vapor is introduced into the chamber C while the interior of the chamber C is maintained constant and/or when the humidity within the chamber C is adjusted are measured by a frequency counter connected to a personal computer. The weight of the mold release agent which is deposited on the surface of the crystal oscillator 27 is calculated from the change in frequency from the initial state, and the deposited film thickness and the coating rate is monitored. When the desired deposited film thickness and coating rate are achieved, the valve provided between the mold release agent supplying section 24 and the chamber C is closed, to complete the mold release process.

### (Substrate for Imprinting)

It is preferable for a quartz substrate to be used with the Si mold in order to enable resist to be exposed. The quartz substrate is not particularly limited, as long as it has light transmissive properties and the thickness thereof is 0.3 mm or greater. Note that the surface of the quartz substrate may be coated with a silane coupling agent or an organic material layer such as that formed by polymers to improve close contact properties with resist. Alternatively, a quartz substrate having a metal layer formed by Cr, W, Ti, Ni, Ag, Pt, Au laminated thereon may be employed. Further, a quartz substrate having a metal oxide layer formed by CrO₂, WO₂, TiO₂, etc. laminated thereon may be employed. Still further, a quartz substrate having a laminated metal layer coated with a silane coupling agent or a laminated metal oxide layer coated with a silane coupling agent may be employed. It is preferable for the thickness of the organic material layer, the metal layer, or the metal oxide layer to be 30 nm or less, and more preferably 20 nm or less. If the thickness of the mask layer exceeds 30 nm, W transmissivity deteriorates, and resist curing failures become more likely to occur.

The expression “light transmissive properties” refers to a degree of light transmissivity that enables sufficient curing of the resist film when light enters a second surface of the substrate 6 opposite a first surface on which the resist film is formed. Specifically, the expression “light transmissive properties” refers to a light transmissivity of 5% or greater from the second surface to the first surface with respect to light having a wavelength of 200 nm or greater.

It is preferable for the thickness of the quartz substrate to be 0.3 mm or greater. If the thickness of the quartz substrate is less than 0.3 mm, it is likely to become damaged during handling or due to pressure during imprinting.

Meanwhile, the shape, structure, size, material, etc. of substrates for use with the quartz mold are not particularly limited. With respect to the shape of the substrate, a substrate having a discoid shape may be utilized in the case that a data recording medium is to be produced, for example. With respect to the structure of the substrate, a single layer substrate may be employed, or a laminated substrate may be employed. With respect to the material of the substrate, the material may be selected from among known materials for substrates, such as silicon, nickel, aluminum, glass, and resin. These materials may be used singly or in combinations of two or more. The substrate may be produced, or a commercially available substrate may be utilized. The thickness of the substrate is not particularly limited, and may be selected according to intended use. However, it is preferable for the thickness of the substrate to be 0.05 mm or greater, and more preferably 0.1 mm or greater. If the thickness of the substrate is less than 0.05 mm, there is a possibility that the substrate will flex during contact with the mold, resulting in a uniform close contact state not being secured.

### (Resist)

The resist is not particularly limited. In the present embodiment, a resist prepared by adding a photopolymerization initiator (2% by mass) and a fluorine monomer (0.1% by mass to 1% by mass) to a polymerizable compound may be employed.

An antioxidant agent (approximately 1% by mass) may further be added as necessary. The resist produced by the above procedures can be cured by ultraviolet light having a wavelength of 360 nm. With respect to resist having poor solubility, it is preferable to add a small amount of acetone or acetic ether to dissolve the resin, and then to remove the solvent.

Examples of the polymerizable compound include: benzyl acrylate (Viscoat #160 by Osaka Organic Chemical Industries, K.K.), ethyl carbitol acrylate (Viscoat™ #190 by Osaka Organic Chemical Industries, K.K.), polypropylene glycol diacrylate (Aronix™ M-220 by TOAGOSEI K.K.), and trimethylol propane PO denatured triacrylate (Aronix™ M-310 by TOAGOSEI K.K.). In addition, a compound A represented by Chemical Formula 1 below may also be employed as the polymerizable compound.

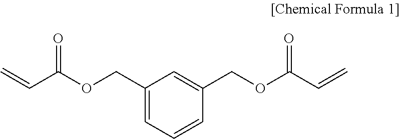 [SMILES: C=CC(=O)OCc1cccc(COC(=O)C=C)c1]

Examples of the photopolymerization initiating agent include alkyl phenone type photopolymerization initiating agents, such as 2-(dimethyl amino)-2-[(4-methylphenyl)methyl]-1-[4-(4-morpholinyl) phenyl]-1-butanone (IRGACURE™ 379 by Toyotsu Chemiplas K.K.)

In addition, a compound B represented by Chemical Formula 2 below may be employed as the fluorine monomer.

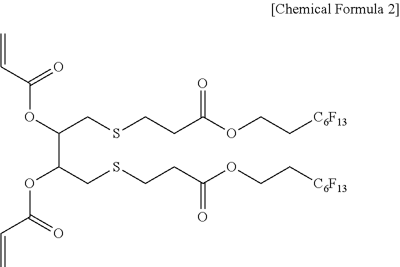

In the present invention, the viscosity of the resist material is within a range from 8 cP to 20 cP, and the surface energy of the resist material is within a range from 25 mN/m to 35 mN/m. Here, the viscosity of the resist material was measured by a RE-80 L rotating viscosity meter (by Touki Industries K.K.) at 25±0.2 C°. The rotating speeds during measurements were: 100 rpm at viscosities greater than or equal to 0.5 cP and less than 5 cP; 50 rpm at viscosities greater than or equal to 5 cP and less than 10 cP; 20 rpm at viscosities greater than or equal to 10 cP and less than 30 cP; and 10 rpm at viscosities greater than or equal to 30 cP and less than 60 cP. The surface energy of the resist material was measured using the technique disclosed in H. Schmitt et al, “UV nanoimprint materials: Surface energies, residual layers, and imprint quality”, J. Vac. Sci. Technol. B., Vol. 25, Issue 3, pp. 785-790, 2007. Specifically, the surface energies of Si substrates that underwent UV ozone processes and the surface of which were treated with Optool DSX (by Daikin Industries K.K.) were measured, then the surface energy of the resist material was calculated from the contact angles thereof with respect to the substrates.

### (Resist Coating Step)

A method that can arrange droplets of a predetermined amount at predetermined positions on the substrate or the mold, such as the ink jet method and the dispensing method, is employed. Alternatively, a method that can coat resist to form a resist film having a uniform film thickness, such as the spin coat method or the dip coat method, is employed.

When the droplets of the resist are arranged on the substrate, an ink jet printer or a dispenser may be used according to desired droplet amounts. For example, in the case that a droplet amount is less than 100 nl, the ink jet printer may be selected, and in the case that a droplet amount is 100 nl or greater, the dispenser may be selected.

Examples of ink jet heads that expel the resist from nozzles include the piezoelectric type, the thermal type, and the electrostatic type. From among these, the piezoelectric type of ink jet head, in which the droplet amount (the amount of resist in each arranged droplet) and the expelling speed are adjustable, is preferable. The amount of droplet amount and the expelling speed are set and adjusted prior to arranging the droplets of the resist onto the substrate. For example, it is preferable for the droplet amount to be adjusted to be greater at regions at which the spatial volume of the pattern of protrusions and recesses of the mold is large, and to be smaller at regions at which the spatial volume of the pattern of protrusions and recesses of the mold is small. Such adjustments are controlled as appropriate according to droplet expulsion amounts (the amount of resist in each expelled droplet). Specifically, in the case that the droplet amount is set to 5 pl, an ink jet head having a droplet expulsion amount of 1 pl is controlled to expel droplets onto the same location 5 times. The droplet amount is obtained by measuring the three dimensional shapes of droplets arranged on a substrate under the same conditions with a confocal microscope or the like, and by calculating the volumes of the droplets from the shapes thereof.

After the droplet amount is adjusted as described above, the droplets are arranged on the substrate according to a predetermined droplet arrangement pattern.

In the case that the spin coat method or the dip coat method is employed, the resist is diluted with a solvent such that a predetermined thickness will be achieved. In the case of the spin coat method, the rotating speed is controlled, and in the case of the dip coat method, the pull up speed is controlled, to form a uniform coated film on the nanoimprinting substrate.

### (Imprinting Method)

The imprinting unit 40 is utilized to perform imprinting operations. Specifically, the imprinting operations are executed as follows.

It is preferable for residual gas to be reduced by depressurizing the atmosphere between the mold and the substrate, or by causing the atmosphere between the mold and the substrate to be a vacuum prior to a mold 1 and resist 7 being placed in contact. However, there is a possibility that the resist 7 will volatilize before curing in a vacuum environment, causing difficulties in maintaining a uniform film thickness. Therefore, it is preferable to reduce the amount of residual gas by causing the atmosphere between a substrate 6 and the mold 1 to be a He atmosphere or a depressurized He atmosphere. He passes through the quartz substrate, and therefore the amount of residual gas (He) will gradually decrease. As the passage of He through the quartz substrate takes time, it is more preferable for the depressurized He atmosphere to be employed. It is preferable for the pressure of the depressurized He atmosphere to be within a range from 1 kPa to 90 kPa, and more preferably a range from 1 kPa to 10 kPa.

The mold 1 and the substrate 6, which is coated with the resist 7, are caused to contact each other after they are aligned to have a predetermined positional relationship. It is preferable for alignment marks to be employed to perform the aligning operation. The alignment marks are formed by patterns of protrusions and recesses which can be detected by the alignment camera 45 or by the Moire interference technique. The positioning accuracy is preferably 10 μm or less, more preferably 1 μm or less, and most preferably 100 nm or less.

The mold 1 is pressed against the substrate at a pressure within a range from 100 kPa to 10 MPa. Copying of the surface shape of the mold 1 to the substrate 6 can be facilitated and the flow of the resist 7 is promoted as the pressure is greater. In addition, the residual gas is removed, the residual gas is compressed, the residual gas is dissolved into the resist, and the passage of He through the quartz substrate is promoted as the pressure is greater. However, if the pressure is excessive, there is a possibility that the mold 1 and the substrate 6 will be damaged if a foreign object is interposed between the mold 1 and the substrate 6 during contact between the mold 1 and the substrate 6. Accordingly, it is preferable for the pressure to be within a range from 100 kPa to 10 MPa, more preferably within a range from 100 kPa to 5 MPa, and most preferably within a range from 100 kPa to 1 MPa. The reason why the lower limit of the pressure is set to 100 kPa is that in the case that the space between the mold and the substrate is filled with liquid when performing imprinting within the atmosphere, the space between the mold and the substrate is pressurized by atmospheric pressure (approximately 101 kPa).

After the mold 1 is pressed against the substrate 6 and the resist film is formed, exposure is performed using light including a wavelength that matches the polymerization initiating agent included in the resist 7, to cure the resist 7. After the resist 7 is cured, the mold is separated from the resist film. As an example of a separating method, the outer edge portion of one of the mold and the nanoimprinting substrate may be held, while the rear surface of the other of the mold and the nanoimprinting substrate is held by vacuum suction, and the held portion of the outer edge or the held portion of the rear surface is relatively moved in a direction opposite the pressing direction. Note that the loading cell 42 may be employed to monitor the force required to release the mold as a separating force.

The imprinting method described above may be executed while changing the relative position of the substrate with respect to the mold 1 in the x-y plane, to continuously form patterns on a plurality of locations on the substrate 6.

### (Method for Producing Copies of Molds)

Next, an embodiment of a method for producing copies of molds will be described. In the present embodiment, a Si mold 1 is employed as an original, and a copy of the mold 1 is produced employing the nanoimprinting method described above.

First, a resist film, on which a pattern has been formed by the nanoimprinting method described above, is formed on a surface of a substrate 6. Then, dry etching is performed using the resist film having the pattern formed thereon as a mask, to form a pattern of protrusions and recesses corresponding to the pattern of protrusions and recesses of the resist film. Thereby, a patterned substrate having a predetermined pattern is obtained.

In the case that the substrate to be processed is of a laminated structure and includes a metal layer on the surface thereof, dry etching is performed using the resist film as a mask, to form a pattern of protrusions and recesses corresponding to the pattern of protrusions and recesses of the resist film in the metal layer. Thereafter, dry etching is further performed with the metal layer as an etching stop layer, to form a pattern of protrusions and recesses in the substrate. Thereby, a substrate having a predetermined pattern is obtained.

The dry etching method is not particularly limited as long as it is capable of forming a pattern of protrusions and recesses in the substrate, and may be selected according to intended use. Examples of dry etching methods that may be employed include: the ion milling method; the RIE (Reactive Ion Etching) method; the sputter etching method; etc. From among these methods, the ion milling method and the RIE method are particularly preferred.

The ion milling method is also referred to as ion beam etching. In the ion milling method, an inert gas such as Ar is introduced into an ion source, to generate ions. The generated ions are accelerated through a grid and caused to collide with a sample substrate to perform etching. Examples of ion sources include: Kauffman type ion sources; high frequency ion sources; electron bombardment ion sources; duoplasmatron ion sources; Freeman ion sources; and ECR (Electron Cyclotron Resonance) ion sources.

Ar gas may be employed as a processing gas during ion beam etching. Fluorine series gases or chlorine series gases may be employed as etchants during RIE.

As described above, the method for producing copies of molds of the present invention employs the resist film having the pattern of protrusions and recesses having few defects formed by the imprinting method described above. Therefore, substrates can be processed with high precision and high yields.

### (Operational Effects of the Present Invention)

Conventionally, there is a problem that imprinting members cannot be sufficiently deformed in cases that the rigidity of the imprinting members is high. Specifically, the problem is as follows.

For example, PCT Japanese Publication No. 2009-518207 discloses a method in which the outer edge portions of the back surface of an imprinting member are suctioned and held, and deformation of the outer edge portions due to suction force flexes the entirety of the imprinting member, as illustrated in FIG. 7. However, because this method depends only on the deformation of the outer edge portions, it is not possible to sufficiently deform imprinting members having high rigidity. Meanwhile, Japanese Unexamined Patent Publication No. 2007-305895 and PCT Japanese Publication No. 2009-518207 disclose methods for flexing imprinting members by suctioning and holding the outer edge portions of the back surfaces thereof, and controlling the pressure in the vicinities of the central portions of the back surfaces of the imprinting members. However, in these methods, the external forces for flexing the imprinting members cannot be made to be too great due to the relationship with the suctioning force for suctioning and holding the imprinting members. Therefore, it is not possible to sufficiently deform imprinting members having high rigidity.

In contrast, according to the nanoimprinting apparatus and the nanoimprinting method of the present invention, the imprinting member to which permanent distortion has been imparted by the distortion imparting device is utilized, the pattern of protrusions and recesses of the mold is pressed against the resist provided on the substrate for imprinting, and the pattern of protrusions and recesses is transferred to the resist. Therefore, the aforementioned problems do not occur.

According to the distortion imparting device and the distortion imparting method of the present invention, external force necessary to deform the imprinting member can be sufficiently applied, and permanent distortion can be imparted to the imprinting member such that the central portion thereof becomes convex, regardless of the rigidity of the imprinting member. As a result, it becomes possible for contact between the pattern of protrusions and recesses of the mold and the resist to be initiated at the center thereof utilizing any imprinting member during nanoimprinting operations, regardless of the rigidity of the imprinting member.

### EXAMPLES

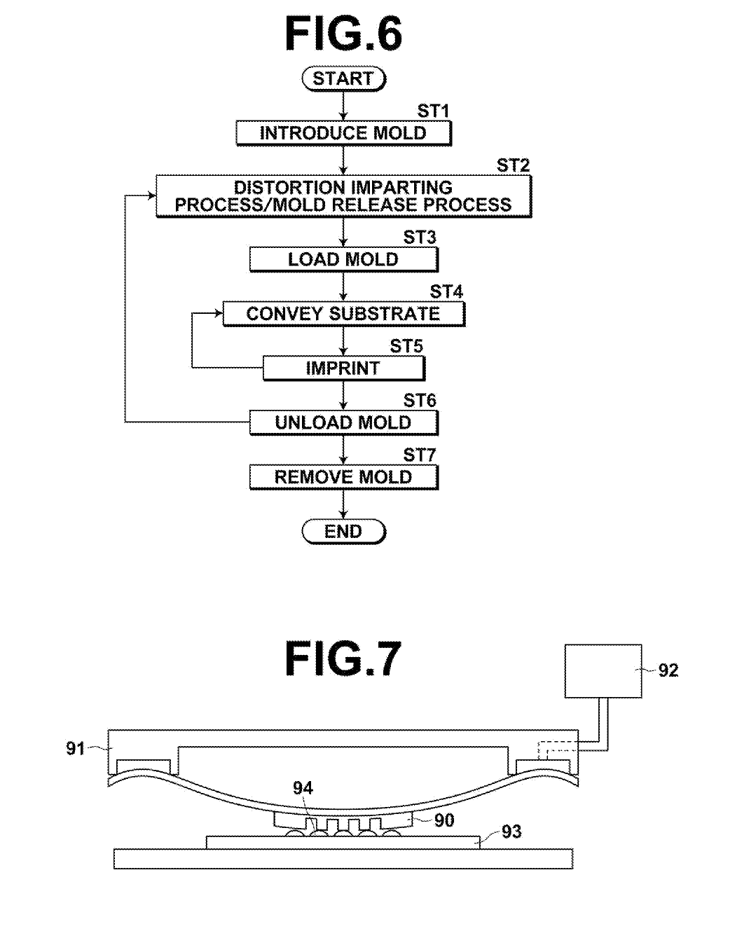

An example of the present invention will be described below. FIG. 6 is a flowchart that illustrates the steps of the imprinting step used with the Example.

### Example 1

### Production of Mold

First, a 0.725 mm thick Si substrate was coated with a resist liquid having a PHS (polyhydroxy styrene) series chemically amplified resist as a main component by the spin coat method, to form a resist layer. Thereafter, an electron beam, which was modulated according to a line pattern having a line width of 30 nm and a pitch of 60 nm, was irradiated onto the resist layer while the Si substrate was scanned on an XY stage, to expose a straight linear pattern of protrusions and recesses on the entirety of a 0.5 mm square range of the resist layer.

Thereafter, the photoresist layer underwent a development process and the exposed portions were removed. Finally, selective etching was performed to a depth of 60 nm by RIE using the resist layer, from which the exposed portions were removed, as a mask, to obtain a Si mold having the straight linear pattern of protrusions and recesses.

### (Substrate for Imprinting)

A quartz substrate was employed as a substrate. The surface of the quartz substrate was processed with KBM-5103 (by Shin-Etsu Chemical Industries, K.K.), which is a silane coupling agent having superior close contact properties with respect to the resist. The KBM-5103 was diluted to 1% by mass using PGMEA, and coated on the surface of the substrate by the spin coat method. Thereafter, the coated substrate was annealed for 5 minutes at 150° C. on a hot plate, causing the silane coupling agent to bond to the surface of the substrate.

### (Resist)

A resist containing the compound A represented by Chemical Formula 1 at 48 w %, Aronix M220 at 48 w %, IRGACURE 379 at 3 w %, and the compound B represented by Chemical Formula 2 at 1 w % was prepared as the resist.

### (Resist Coating Step)

DMP-2831, which is an ink jet printer of the piezoelectric type by FUJIFILM Dimatix, was utilized. DMC-11610, which is a dedicated 10 pl head, was utilized as an ink jet head. Ink expelling conditions were set and adjusted in advance such that the amount of resist in each droplet was 10 pl. After the droplet amount was adjusted in this manner and adjustments were made such that a residual film thickness will become 10 nm, droplets were arranged on the substrate according to a predetermined droplet arrangement pattern.

### (Introduction of Mold)

The Si mold was housed in a cassette, and a housing case of the cassette was placed in the mold cassette loader. The mold cassette loader opened the housing case, and the conveying device was employed to load the mold onto the distortion imparting device (ST1).

### (Distortion Imparting Process and Mold Release Process)

The distortion imparting device vacuum chucked the outer edge portions of the mold such that the patterned surface of the mold faced the interior thereof. First, the atmosphere within the chamber was replaced with oxygen and the low pressure mercury lamp was used to irradiate light, to cleanse the surface of the mold. Next, the atmosphere within the chamber was replaced with atmospheric gas, and the pump, the humidity control section and the heater were employed to maintain a depressurized atmosphere of 50 kPa, 50° C., and a relative humidity of 50%. The mold release agent supplying section was filled with CF₃(CF₂)₅(CH₂)₂Si (OCH₃) the valve of the mold release agent supplying section was opened to introduce a gas containing the mold release agent to the chamber, and the surface of the mold was exposed to the gas for 12 hours (ST2).

By the above processes, the mold was imparted with permanent distortion in which the central portion of the mold was flexed 50 μm compared to the outer peripheral portions thereof. At the same time, a mold release process was administered on the patterned surface of the mold. A mold which was previously loaded is present in the imprinting unit, and imprinting was executed with the loaded mold while the mold undergoing the above processes was in a standby state. Note that in the case that a mold is not present in the imprinting unit and a processed mold is loaded into the nanoimprinting apparatus, the above processes may be skipped and the mold may be directly loaded into the imprinting unit.

### (Loading of Mold)

The conveying device was employed to unload the used mold from the imprinting unit (ST6), and the new mold was loaded into the imprinting unit from the distortion imparting device (ST3). The used mold was conveyed to the distortion imparting device and cleansed. Thereafter, the cleansed mold underwent the shape control process and the mold release process again (ST2).

### (Conveyance of Substrate)

The quartz substrate having resist coated thereon was housed in a cassette, and a housing case of the cassette was placed in the substrate cassette loader. The substrate cassette loader opened the housing case, and the conveying device was employed to convey the substrate to the imprinting unit (ST4).

### (Imprinting)

The mold and the quartz substrate were caused to approach each other such that the gap therebetween was 0.1 mm or less, and positioning was performed from the rear surface of the quartz substrate such that the positions of the alignment marks on the quartz substrate matched the positions of the alignment marks on the mold.

The space between the mold and the quartz substrate was replaced with a gas which is 99% He by volume or greater. Then, depressurization was performed to 20 kPa or less. The mold was caused to contact the droplets of resist under the depressurized He conditions. The flexure of the mold caused the mold to contact the resist from the central portion thereof, and the entirety of the mold came into uniform close contact with the resist, without any gas being interposed therebetween (ST5).

After contact, a pressure of 1 MPa was applied for 10 seconds, and ultraviolet light including a wavelength of 360 nm as irradiated at an irradiation dosage of 100 mJ/cm², to cure the resist.

Thereafter, the back surfaces of the quartz substrate and the mold were held by suction. Then, the quartz substrate or the mold was relatively moved in a direction opposite the pressing direction to separate the mold. The force required to release the mold was monitored as a separating force.

### (Unloading of Mold)

A value of ±30% with respect to an average separating force from a 10th imprinting operation to a 30th imprinting operation was designated as a threshold value. When the separating force exceeded the range of ±30%, imprinting operations and conveyance of substrates was ceased. The used mold was unloaded from the imprinting unit using the conveying device (ST6). The used mold was conveyed to the distortion imparting device and cleansed. Thereafter, the cleansed mold underwent the distortion imparting process and the mold release process again (ST2).

### (Removal of Mold)

In the case that a mold was not to be reused, the mold was unladed from the imprinting unit, housed in the mold cassette by the conveying device, then removed (ST7).

### (Mold Copy Production Step)

Dry etching was performed as described below using the resist film, on which the pattern of protrusions and recesses is transferred, as a mask. Thereby, shapes of protrusions and recesses based on the pattern of protrusions and recesses of the resist film were formed on the quartz substrate.

First, the residual film present at the recesses of the pattern was removed by oxygen plasma etching, to expose the quartz substrate at the recesses of the pattern. At this time, conditions were set such that the amount of etching is capable of removing the thickest residual film within the region of the pattern of protrusions and recesses. Next, RIE using a fluorine series gas was administered on the quartz substrate, using the protrusions of the pattern as a mask. The RIE conditions were set such that the depth of etching was 60 nm. Finally, the residue of the protrusions of the pattern was removed by oxygen plasma etching.

A copy quartz mold having the pattern of protrusions and recesses of the Si mold accurately transferred thereto was produced by the above mold copy production steps.

What is claimed is:

1. A nanoimprinting apparatus, comprising:
a distortion imparting device that applies external force onto an imprinting member, which is one of a mold having a fine pattern of protrusions and recesses on a first surface thereof and a substrate for nanoimprinting having resist on a first surface thereof, to maintain the imprinting member in a predetermined flexed state, thereby imparting permanent distortion to the imprinting member; and
an imprinting unit that utilizes the imprinting member having the permanent distortion imparted thereto and presses the pattern of protrusions and recesses of the mold onto the resist provided on the substrate, to transfer the pattern of protrusions and recesses to the resist.

2. A nanoimprinting apparatus as defined in claim 1, wherein:
the distortion imparting device comprises a frame having an opening, that forms a chamber above the first surface of the imprinting member when the imprinting member is placed at the opening with the first surface facing the interior of the frame, and a pressure control section that depressurizes or pressurizes the interior of the chamber.

3. A nanoimprinting apparatus as defined in claim 2, wherein:
the distortion imparting device further comprises a heating section that heats the interior of the chamber.

4. A nanoimprinting apparatus as defined in claim 2, wherein:
the distortion imparting device further comprises a mold release agent supplying section that supplies a mold release agent to the interior of the chamber.

5. A nanoimprinting apparatus as defined in claim 3, wherein:
the distortion imparting device further comprises a mold release agent supplying section that supplies a mold release agent to the interior of the chamber.

6. A nanoimprinting apparatus as defined in claim 4, wherein:
the distortion imparting device further comprises a humidity controlling section that controls the humidity of interior of the chamber.

7. A nanoimprinting apparatus as defined in claim 5, wherein:
the distortion imparting device further comprises a humidity controlling section that controls the humidity of interior of the chamber.

8. A nanoimprinting apparatus as defined in claim 1, wherein:
the distortion imparting device comprises a support member that supports the outer edges of the imprinting member, and a pressing member that presses a second surface of the imprinting member while the imprinting member is being supported by the support member.

9. A distortion imparting device that performs the function of applying external force onto an imprinting member, which is one of a mold having a fine pattern of protrusions and recesses on a first surface thereof and a substrate for nanoimprinting having resist on a first surface thereof, to maintain the imprinting member in a predetermined flexed state, thereby imparting permanent distortion to the imprinting member, comprising:
a frame having an opening, that forms a chamber above the first surface of the imprinting member when the imprinting member is placed at the opening with the first surface facing the interior of the frame; and
a pressure control section that depressurizes or pressurizes the interior of the chamber.

10. A distortion imparting device that performs the function of applying external force onto an imprinting member, which is one of a mold having a fine pattern of protrusions and recesses on a first surface thereof and a substrate for nanoimprinting having resist on a first surface thereof, to maintain the imprinting member in a predetermined flexed state, thereby imparting permanent distortion to the imprinting member, comprising:
a support member that supports the outer edges of the imprinting member; and
a pressing member that presses a second surface of the imprinting member while the imprinting member is being supported by the support member.
